(19) United States
(12) Patent Application Publication
(10) Pub. No.: US 2007/0236655 A1
(43) Pub. Date: Oct. 11, 2007

(54) Contact lens device to remove or assist in the removal of a contact lens

(76) Inventor: Stanton Kim, Gilroy, CA (US)

Correspondence Address: DR. STANTON KIM, 10760 GREEN VALLEY DR, GILROY, CA, 95020, US

(21) Appl. No.: 11/393,170

(22) Filed: Mar. 29, 2006

(51) Int. Cl. G02C 7/04

(52) U.S. Cl. 351/160 R

(57) ABSTRACT

A contact lens device comprising a lens support having a concave surface that is treated or modified to grip, rub, or adhere to a contact lens, and a method of using the contact lens device. A handle or stem is coupled to the lens support for positioning the lens support during the process of removing a contact lens from a wearer's eye.

### FIELD OF THE INVENTION

The present invention relates generally to a soft contact lens device during the removal of a soft contact lens from the surface of an eye.

### BACKGROUND

Contact lenses can be made to correct most visual conditions correctable by regular eyeglasses. Moreover, contact lenses are not readily visible and provide the user with a wider field of vision than do eyeglasses. The first contact lenses were of the “hard” variety, that is to say, they are lathe cut and polished or are molded of a relatively rigid material, and formed by heat and pressure to the shape of a wearer's or user's eye. The user must learn to wear them over a period of time. Many persons have experienced difficulty in wearing hard contact lenses.

A recent innovation has been the “soft” contact lens constructed of flexible, liquid absorbent, and gas permeable material. Although soft contact lenses are comfortable to wear, the soft contact lens has some problems, including difficulty of removal. Such known devices have included holders, suction apparatus, spring-loaded devices, and eyepieces. Generally, soft contact lenses are removed by the wearer moving the contact lens off the cornea onto the sclera and pinching the soft contact between his fingertips, thereby removing the contact lens from the eye. Unfortunately, some people have difficulty in removing the contact lens because of their difficulty in placing their fingers on the cornea, while others have long or sharp fingernails and still others are generally clumsy having large fingers.

One type of contact removing device uses a tweezers action. Examples of tweezers type contact lens removers are in U.S. Pat. No. 4,192,204 to Feldman entitled “Soft Contact Lens Apparatus” and in U.S. Pat. No. 4,986,586 to Eilrich et al. entitled “Device for Removing Soft Contact Lens.” By holding a tweezers device in either hand, using the thumb and the fore finger, the device is brought up to the eye having a contact lens. Using the fingers to compress and operate the tweezers, gentle pressure is put onto the contact lens with the tips, and the device is squeezed together in a tweezers motion. The contact lens is gripped and gently pulled away from the eye, removing the contact lens. Tweezers type devices may be used to successfully remove a soft contact lens however, a tweezers device may also be prone to cause damage to a soft contact lens.

Other devices may be described generally as cup or suction devices. A suction or capillary action is developed between the lens and the device for holding the lens in a desired position during the application or removal of a lens. For example, U.S. Pat. Number D310,380 to England entitled “Contact Lens Remover” uses a cup design.

A scissoring may be difficult to use or align with the contact lens, and cup devices may not be able to develop enough of a capillary action to remove a contact lens from the surface of the eye.

### SUMMARY OF THE INVENTION

A contact lens device comprising a lens support having a concave surface to remove or assist in the removal of a contact lens from a wearer's eye.

### BRIEF DESCRIPTION OF THE DRAWINGS

FIG. 1A is a cross section of an exemplary contact lens device as it comes into contact with a contact lens on the corneal area of a human eye.

FIG. 1B is a cross section of the exemplary contact lens device of FIG. 1A as it is pressed toward the contact lens and flexes to conform to the surface of the contact lens.

FIG. 2A is a cross section of an another embodiment of the contact lens device of FIG. 1A.

FIG. 2B is a cross section of an alternate embodiment of a contact lens device.

FIG. 2C is a cross section of another alternate embodiment of a contact lens device.

FIG. 2D is a cross section of the contact lens device of FIG. 2C as it is pressed or pushed toward a contact lens in a human eye and flexes to conform to the contact lens surface.

FIG. 3A is a cross section of the exemplary contact lens device of FIG. 1A, showing an exemplary location or area of a treated surface.

FIG. 3B is a front and cross sectional view of a treated surface pattern.

FIG. 3C is another front and cross sectional view of an alternate treated surface pattern.

FIG. 3D is an AA view of an embodiment of the cross-section of FIG. 3A.

FIG. 3E is an AA view of alternate embodiment of the cross-section of FIG. 3A.

FIG. 3F is an AA view of an another alternate embodiment of the cross-section of FIG. 3A.

FIG. 4A is a cross section of an exemplary contact lens device as it is pressed toward a contact lens that is on the surface of a human eye.

FIG. 4B is a cross section of an exemplary contact lens device as it is released and pulled away from the human eye.

### DETAILED DESCRIPTION

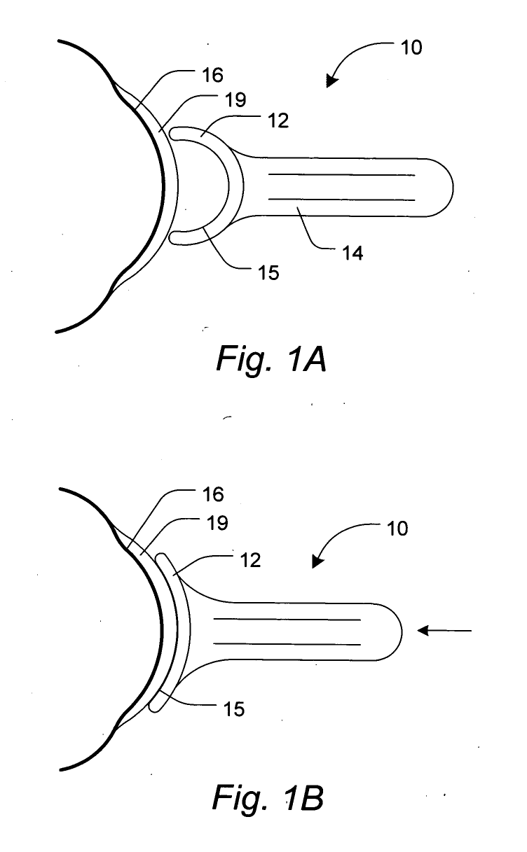

Referring to FIG. 1A, an exemplary contact lens device 10 comprises a handle or stem 14 coupled to a lens support 12. The lens support 12 has a concave surface 15 having a radius of curvature smaller than the radius of curvature of a contact lens 19 in a human eye 16, or the radius of curvature of a corneal section of a wearer's eye 16. In specific embodiments, the concave surface 15 radius of curvature is approximately 5 millimeters to 10 millimeters, depending on the dimensions of the wearer's eye or the age of the wearer of the contact lens. The concave surface 15 radius of curvature is smaller than the radius of curvature of a contact lens 19 that has been inserted onto the surface of the wearer's eye.

Referring to FIG. 1B, the lens support 12 is comprised of or made of a flexible material such as rubber, Styrofoam, plastic, sponge, or another flexible material. Optionally, the lens support 12 may also be comprised of a combination of flexible, semi-flexible, or hard materials. When the lens support 12 and concave surface 15 is applied or pressed against a contact lens 19 on the eye, the concave surface 15 flexes, to open up or increase the radius of curvature, to accommodate or approximately match the radius of curvature of the contact lens 19 on the eye. The lens support 12 and concave surface 15 of the lens support 12 generally has an un-flexed dimension that is approximately equal to or smaller than the outside diameter of a contact lens.

A handle or stem 14 is comprised of or made of a flexible material such as rubber, Styrofoam, plastics, sponge, or other flexible materials. Optionally, the handle or stem 14 may also be comprised of a combination of flexible, semi-flexible, or hard materials. The flexible materials are sufficiently resilient to permit deflection of the handle or stem 14 and/or the lens support 12, upon application of the contact lens device 10 to a contact lens in a wearer's eye to ensure contact between the contact lens device 10 and the surface of the contact lens 19 without injuring the eye 16.

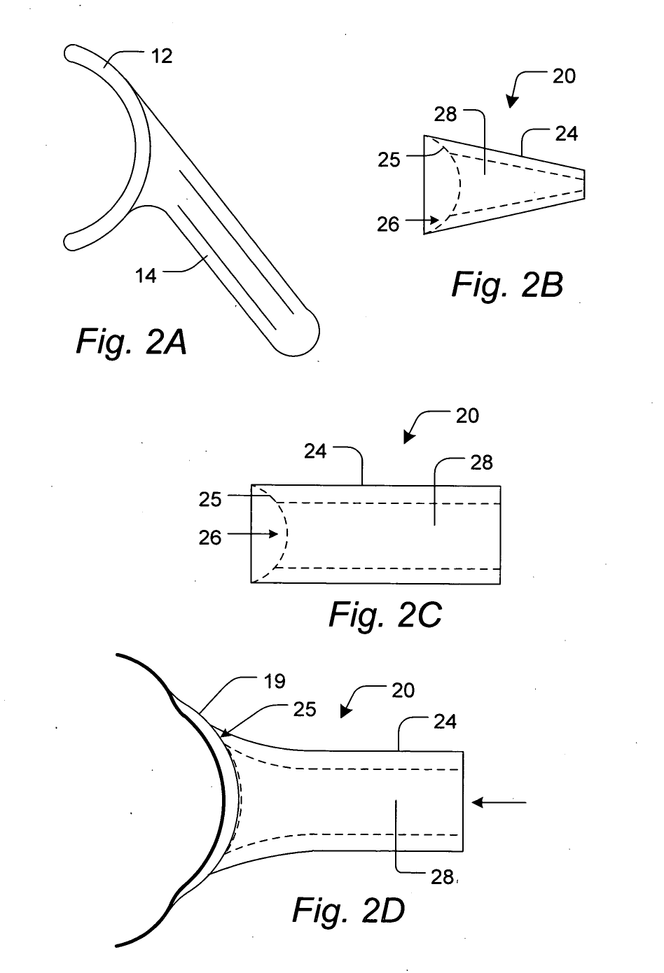

Referring to FIG. 2A, the handle or stem 14 may be optionally coupled to the lens support 12 at a variety of angles. Also, an additional contact lens insertion portion or contact lens holding device may optionally be coupled to or attached to the handle or stem 14. Referring to FIG. 2B, in an alternate embodiment, a contact lens device 20 having a handle or stem 24 may also exist in a variety of shapes, dimensions, and proportions. A concave surface 25 of a lens support 26 area may have a solid or continuous surface, or optionally may have a non-continuous surface further comprising a single opening 28 or a plurality of openings. A non-continuous surface of a lens support 26 area may be used to vent, prevent, or control the suction or capillary action between the concave surface 25 and a contact lens. A contact lens device 20 for example, may have a concave surface 25 and a single opening 28 that extends through the handle or stem 24.

Referring to FIG. 2C, in another alternate embodiment, a contact lens device 20 may be shaped as a hollow cylinder having a handle or stem 24, a lens support 25 area, and a single opening 28. Referring to FIG. 2D, when the contact lens device 20 is applied or pressed against a contact lens 19 on a wearer's eye, the lens support 25 flexes, to open up or increase the radius of curvature, to accommodate or match the radius of curvature of the contact lens 19 on the eye.

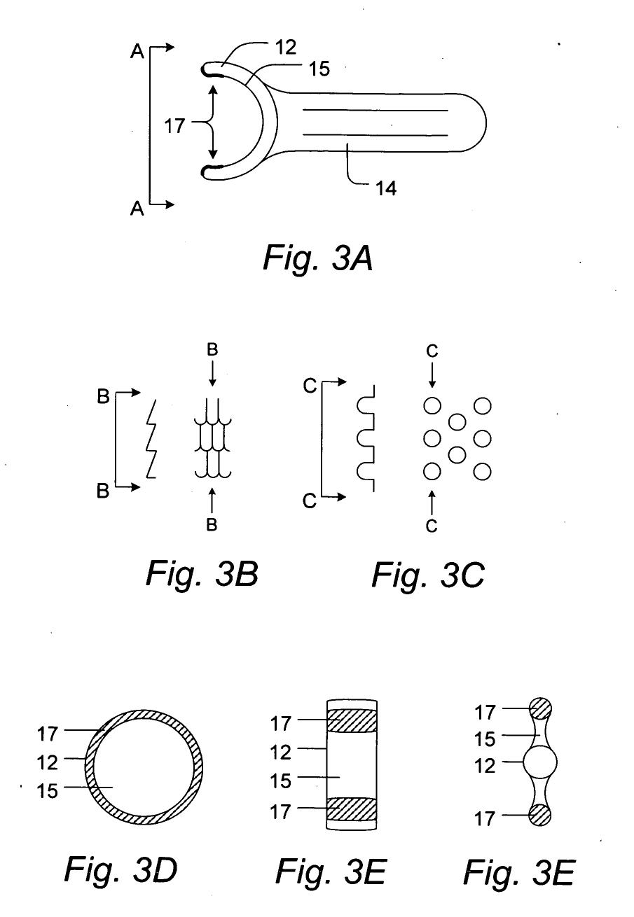

Referring to FIG. 3A, a modified area 17 approximately located on the lens support 12 is treated or modified to provide a gripping, frictional, or adhesive property. The entire concave surface 15 or a portion of the concave surface may be treated or modified. The gripping, frictional, or adhesive property overcomes a contact lens-to-eye surface tension during the removal of a contact lens. In one embodiment, the concave surface 15 or a portion of the concave surface may be treated or modified to comprise a surface pattern. For example, a scale pattern, ridges, or protrusions may be molded or added onto the concave surface 15 or onto a portion of the lens support 12 area.

Referring to FIGS. 3B and 3C, a surface pattern or surface texture in the modified area 17 provides a gripping property or frictional force when the lens support 12 of the contact lens device is applied to the surface of a contact lens. Referring to FIG. 3B, a scale pattern embodiment, oriented to provide a slipping effect on one direction, and a gripping effect in the opposite direction may be used. Referring to FIG. 3B, a pattern of ridges or tips may also be used. The ridges or tips may uniformly grip in all directions, but the integrity of the contact lens material will allow the ridges or tips to slide over the surface of the contact lens during the application or pressing phase of using the contact lens device. When the contact lens device is then released or pulled away from the eye, the ridges or tips will provide enough friction to grip the contact lens surface. A pattern of ridges or tips emulate friction caused by a finger print when a contact lens wearer uses their finger tips to remove a contact lens.

In another embodiment of the modified area 17, the modified area 17 comprises an adhesive material. The adhesive material may be pre-applied or may be applied by the user of the contact lens device. For example, the contact lens device may be dipped into an adhesive material or an adhesive solution by the user of the contact lens device just prior to removing a contact lens.

The contact lens device may be implemented in a variety of shapes. Referring to FIG. 3D, the contact lens device front view (from view AA in FIG. 3A) may be embodied as a single cup lens support 12 incorporating the modified area 17 as a single circle or ring pattern. In alternative embodiments, a plurality of rings or arrangement of circles, or a distributed pattern of circles may be incorporated for the modified area 17. Referring to FIG. 3E, another alternate embodiment of a contact lens device has a flat shape having a plurality of modified areas 17 on a lens support 12. Referring to FIG. 3F, yet another alternative embodiment of a contact lens device has a plurality of modified areas 17 on each end of a lens support 12. The modified areas 17 may have surfaces that are patterned, an adhesive, or a suction cup having a smooth surface.

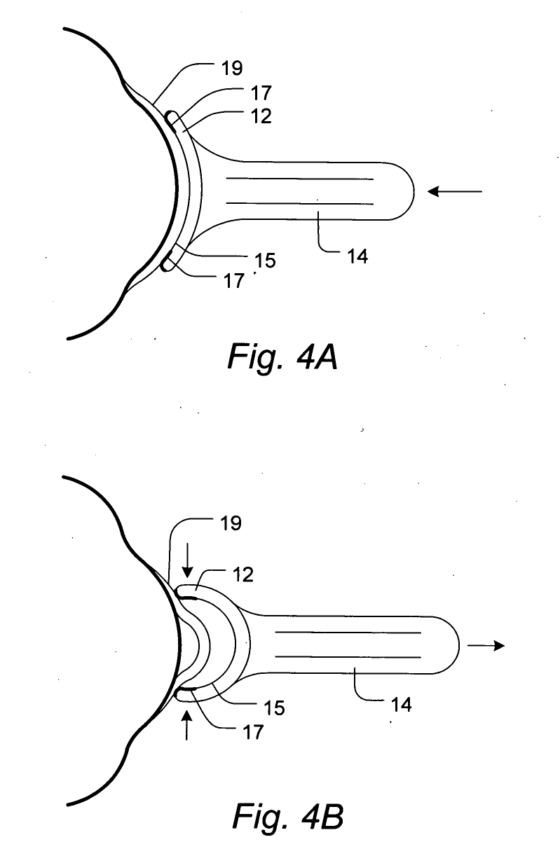

After a contact lens has been inserted into a wearer's eye, the contact lens device may then be used to remove or assist in the removal of a contact lens from a wearer's eye. Referring to FIG. 4A, the handle or stem 14 is held by either the wearer of the contact lens or an assistant to aid in positioning the lens support 12 during the removal of a contact lens from the wearer's eye. The contact lens device is carefully placed so that a portion of the lens support 12 comes into contact with the contact lens in the wearer's eye. In one embodiment, the concave surface of the lens support has a lens contact diameter approximately between 4 millimeters to 15 millimeters. When the lens support 12 is applied, pushed, or pressed toward or against the contact lens 19 that is on the surface of a wearer's eye, the lens support 12 and concave surface 15 flex to increase the radius of curvature of the concave surface 15. The flexed radius of curvature may increase, or may accommodate or approximately match the radius of curvature and surface of the contact lens 19 on the eye (as shown in FIG. 4A). Generally, the modified area 17 moves over the surface of the contact lens 19, however, the modified area 17 may not engage or contact the surface of the contact lens 19 until the concave surface 15 and/or lens support 12 and has flexed to accommodate or approximately match the radius of curvature and surface of the contact lens 19.

Referring to FIG. 4B, as the pressure applied to the contact lens device is then reduced, or released, or pulled away from the eye and contact lens 19, the lens support 12 begins to return to its original shape and radius of curvature. The modified area 17 sufficiently grips or holds, rubs or provides a frictional force, adheres to, and also operationally “pinches” the contact lens 19 to deform the contact lens 19 shape (for example for a soft or semi-hard contact lens), or pulls the contact lens (for example, for a semi-hard, or hard contact lens) to overcome a lens-to-eye capillary attraction or surface tension. The contact lens 19 then no longer fully conforms to or fully rests on the corneal surface of the eye. The contact lens 19 is then removed from the eye as the contact lens device is withdrawn from the wearer's eye, or the contact lens 19 is removed by the wearer's blinking.

In another embodiment of the contact lens device, the modified area 17 comprises at least one patterned area on a lens support 12. The patterned area, for example, may be a ridge or pattern providing a gripping, frictional, or adhesive property to the edge of a contact lens. The lens support 12 dimension, in an un-flexed state, is smaller than the diameter of a contact lens. When the lens support 12 is applied to the surface of a contact lens and pushed, or pressed toward or against the contact lens 19 that is on the surface of a wearer's eye. The modified area 17 moves over the surface of the contact lens 19 and the concave surface 15 flexes to a size that is larger than the diameter of the contact lens 19. The modified area 17 grips, adheres to, or catches at least one outer edge of the contact lens. As pressure against the contact lens 19 and eye is then released and pulled away from the eye, the lens support 12 begins to return to its original shape and radius of curvature, the contact lens 19 overcomes a lens-to-eye capillary attraction or surface tension (for a soft, semi-hard, or hard contact lens), or the contact lens 19 deforms (for a soft contact lens), and no longer fully conforms to or fully rests on the corneal surface of the eye. The contact lens 19 is then removed from the eye as the contact lens device is withdrawn from the wearer's eye, or the contact lens 19 is removed by the wearer's blinking.

The present invention is not to be limited in scope by the specific embodiments described herein. Indeed, various modifications of the invention in addition to those described herein will become apparent to those skilled in the art from the foregoing description and accompanying figures. For example, the lens support has been described as having a concave surface with a radius of curvature that is smaller than the radius of curvature of the surface of a contact lens. Other embodiments and shapes, such as using an open ended octagon approximating a radius of curvature and flexing to approximate a lens distorting or removing procedure or operation. Such modifications are intended to fall within the scope of the appended claims. In addition, embodiments using pivotal arms and spring mechanisms that approximately provide the flexure and friction or gripping properties to distort a contact lens during a removal process are also intended to fall within the scope of the appended claims.

I claim:

1. A contact lens device comprising:
a handle or stem member;
a lens support coupled to the stem or handle member;
the lens support having a concave surface; the concave surface of the lens support having a radius of curvature that is less than the radius of curvature of an eye;
the concave surface of the lens support being sufficiently flexible to accommodate to the radius of curvature of the eye; and
the lens support comprising a modified area, the modified area being configured to provide a gripping or frictional force when in contact with a contact lens.

2. The contact lens device of claim 1, wherein the handle or stem member comprises a flexible material.

2. The contact lens device of claim 2, wherein the lens support material comprises a rubber, a Styrofoam, a plastic, or a sponge material.

3. The contact lens device of claim 1, wherein the concave surface of the lens support has an approximate radius of curvature between approximately 5 millimeters to 10 millimeters.

4. The contact lens device of claim 1, wherein the concave surface of the lens support has an un-flexed dimension that is approximately equal to or smaller than the outside diameter of a contact lens.

5. The contact lens device of claim 4, wherein the concave surface of the lens support has a lens contact diameter approximately between 4 millimeters to 15 millimeters.

6. The contact lens device of claim 1, wherein the lens support modified area comprises a surface texture or pattern having a gripping or frictional force when applied to the surface of a contact lens.

7. The contact lens device of claim 1, wherein the lens support modified area slides over a contact lens surface as the contact lens device conforms to the overall contact lens surface, and grips, rubs, or adheres to the contact lens as the contact lens device is withdrawn from the eye.

8. The contact lens device of claim 1, wherein the lens support modified area comprises at least one suction cup having a gripping or frictional force when applied to the surface of a contact lens.

9. The contact lens device of claim 1, wherein the lens support modified area comprises an adhesive material.

10. The contact lens device of claim 9, wherein the adhesive material is applied to the lens support by the user of the contact lens device.

11. The contact lens device of claim 1, wherein the flexible characteristic of the lens support and modified area are configured to operationally contact, grip or rub, and operationally distort the shape of a contact lens.

12. The contact lens device of claim 1, wherein the flexible characteristic of the lens support and modified area are configured to operationally contact and pull a hard or semi-hard contact lens so that the contact lens no longer fully rests on the corneal surface of the eye.

13. The contact lens device of claim 1, wherein the handle or stem member comprises a tubular construction having a longitudinal or conical opening aligned with an opening in the lens support.

14. A method of removing a contact lens from a wearer's eye comprising:
applying a device having a flexible lens support to a contact lens that is on the surface of a wearer's eye, the lens support comprising a concave surface having a radius of curvature that is less than the radius of curvature of the contact lens on the surface of the wearer's eye;
pushing the lens support toward the contact lens and flexing the concave surface to increase the radius of curvature of the concave surface; and
pulling the lens support away from the contact lens, allowing the concave surface to return to its original shape and radius of curvature; and
causing the contact lens to no longer fully conform to the surface of the eye.

15. The method of claim 14, wherein a portion of the lens support grips or rubs the contact lens.

16. The method of claim 14, wherein a portion of the lens support comprises a patterned surface that grips or rubs the contact lens.

17. The method of claim 14, wherein a portion of the lens support adheres to the contact lens.

18. The method of claim 14, further comprising deforming the contact lens.

19. A method of removing a contact lens from a wearer's eye comprising:
applying a device having a flexible lens support to a contact lens that is on the surface of a wearer's eye, the lens support comprising a concave surface having a radius of curvature that is less than the radius of curvature of the contact lens on the surface of the wearer's eye;
pushing the lens support toward the contact lens and flexing the concave surface to approximately match the radius of curvature of the surface of the contact lens on the eye;
pulling the lens support away from the contact lens, allowing the concave surface to return to its original shape and radius of curvature; and
pulling the contact lens to no longer fully rest on the surface of the eye.

20. The method of claim 19, wherein a portion of the lens support grips or rubs the contact lens.

21. The method of claim 19, wherein a portion of the lens support comprises a patterned surface that grips or rubs the contact lens.

22. The method of claim 19, wherein a portion of the lens support adheres to the contact lens.

23. The method of claim 19, further comprising deforming the contact lens.
